(19) United States
(12) Patent Application Publication
(10) Pub. No.: US 2019/0317497 A1
(43) Pub. Date: Oct. 17, 2019

(54) AUTONOMOUS VEHICLE

(71) Applicant: Bedestrian LLC, Ann Arbor, MI (US)

(72) Inventor: Shadi Mere, Ann Arbor, MI (US)

(21) Appl. No.: 15/953,016

(22) Filed: Apr. 13, 2018

(51) Int. Cl. G05D 1/00; G05D 1/02; G06Q 10/08

(52) U.S. Cl. CPC G05D 1/0088; G05D 1/0276; G05D 2201/02; G06Q 10/0832; G05D 1/0231

(57) ABSTRACT

An autonomous vehicle for transporting an item from a first location to a second location includes a vehicle frame having a first set of three guide wheels and a second set of three guide wheels. A pair of road wheels are rotatably engaged with each of the first and second set of three guide wheels. A pair of electric motors are mounted to the frame and drive the road wheels. A compartment is disposed in the interior of the vehicle. Sensors are mounted on the frame for collecting date for determining an environment in which the vehicle is operating. A control module processes data received by the sensors and controls the electric motors to move the vehicle in the environment according to instructions sent by a remote source. A user interface is in communication with the control module for providing a means to communicate with the vehicle.

### TECHNICAL FIELD

The present invention generally relates to the field of autonomous vehicles and, more specifically to autonomous vehicles that are configured to carry and deliver items from one location to another.

### BACKGROUND

The statements in this section merely provide background information related to the present disclosure and may or may not constitute prior art.

Delivery truck drivers and salespeople pick up, transport, and drop off packages, food delivery, prescription drugs, and small shipments within a local region or urban area. Merchandise is transported from a distribution center, or local business to other businesses and households. The delivery service is fragmented, unoptimized logistically, and many areas are underserved, and services are limited to certain times of the day and week instead of twenty-four hours seven days a week, year around. The vehicles used in delivery most often do not have storage with a temperature-controlled compartment to carry cold or hot features for temperature sensitive goods, in addition, these vehicles do not have sensors such as weight, temperature humidity, etc. to monitor the environmental conditions of the cargo. Other vehicles do not deliver to the last step or at the door services due to stairs or elevators, they deliver only to the curbside. In addition, drivers and workers have low average wages, and poor benefits. The carbon footprint of the delivery industry is large and has large negative consequences on the environment in congestion and pollution.

There is also a demand for moving small items that do not fit small or medium size cars for consumers. A consumer who buys a chair or a big painting for example has to rent a trailer or a small truck, or alternatively pay for delivery with longer wait times and inconvenient delivery time and higher cost as a percentage of the item purchased.

Therefore, there is a need for a more efficient and convenient system for delivering items or goods from one location to another. The delivery system should be autonomous and reduce the need for human intervention in the task of delivering an item.

### SUMMARY

In an embodiment of present invention, an electric micro semi-truck vehicle includes of a robot vehicle and a trailer dynamically connected thereto. The micro semi-truck is guided by a combination of an autonomous system, as well as a system remotely monitored by humans. The robot vehicle is powered by a battery and has its own temperature-controlled storage and is disengable from the trailer to make deliveries. The trailer has its own battery and is capable of navigating as an independent vehicle and make deliveries or follow another vehicle. Both the robot vehicle and the trailer are used for delivering goods, services, and humans, they both have storage compartments that are temperature controlled. The vehicles operate with mobility-as-a-service purpose for on demand and scheduled service relating to delivery, as well as trailing behind other vehicle attached or unattached to carry goods. The robot vehicle and trailer operate as an autonomous delivery system for delivering goods and services on open roads and sidewalks, and enclosed spaces such as hospitals, prisons, municipal and government facilities, care facilities and industrial facilities.

Further aspects, examples, and advantages will become apparent by reference to the following description and appended drawings wherein like reference numbers refer to the same component, element or feature.

### BRIEF DESCRIPTION OF THE DRAWINGS

The drawings described herein are for illustration purposes only and are not intended to limit the scope of the present disclosure in any way.

FIG. 1 is a front perspective view of an exemplary autonomous vehicle;

FIG. 2 is an exploded front perspective view of the autonomous vehicle;

FIG. 3 is a partial side cross-sectional view of the autonomous vehicle; and

FIG. 4 is a side schematic view of the autonomous vehicle.

### DESCRIPTION

The following description is merely exemplary in nature and is not intended to limit the present disclosure, application, or uses.

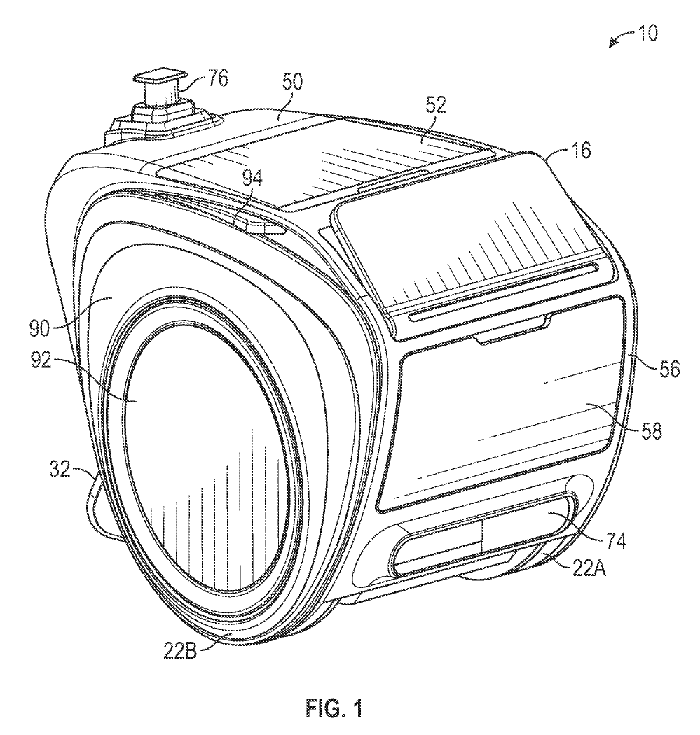

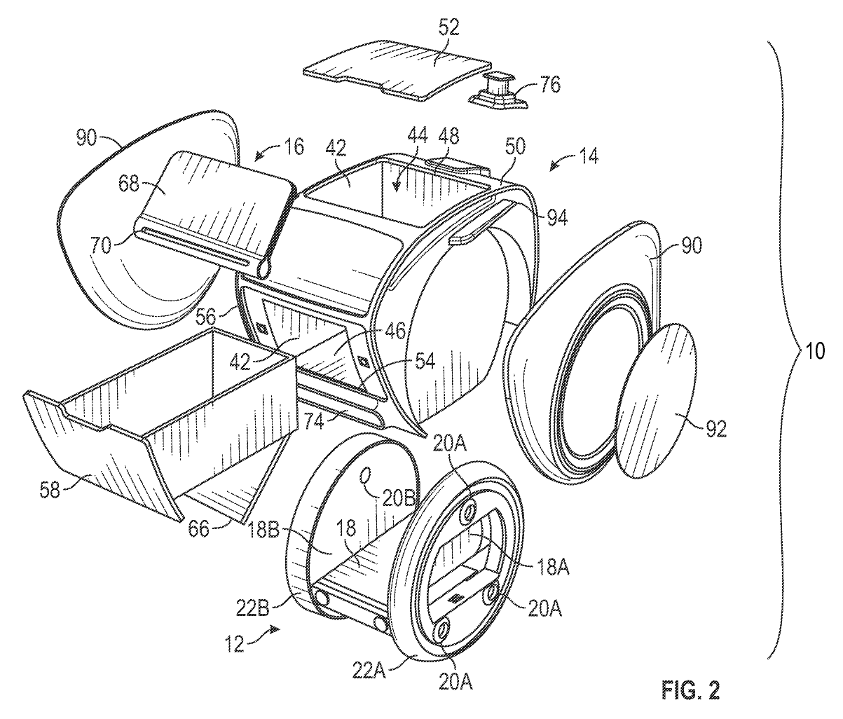

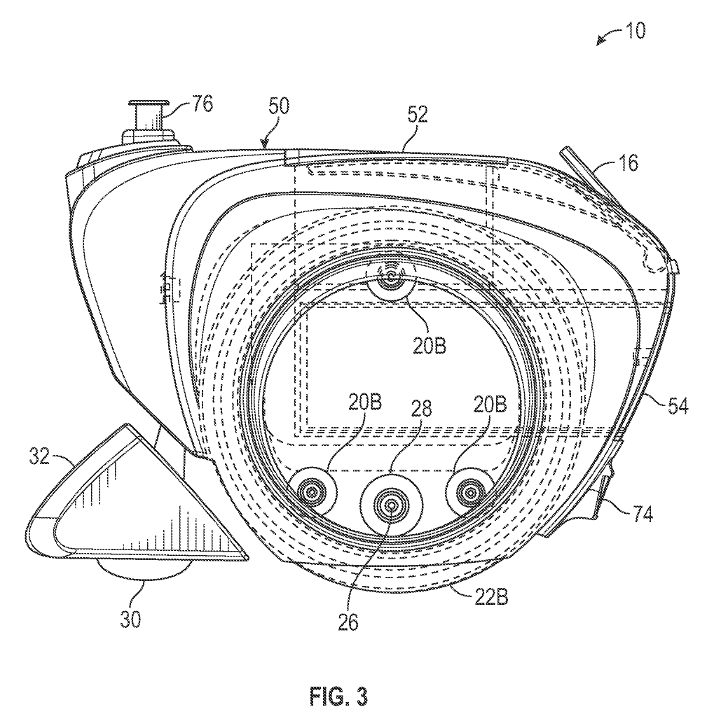

With reference to FIGS. 1-4, an autonomous vehicle is generally indicated by reference number 10. The autonomous vehicle 10 is generally used for transporting an item from at least a first location to at least a second location autonomously. The first location and the second location may be in any number of places within a locality or range of the autonomous vehicle 10. For example, specific use cases of the autonomous vehicle 10 include transporting medicine between various locations in a hospital, transporting lab equipment within a lab, transporting items within an office building or warehouse, transporting items from a distribution hub to a residence, etc. Thus, the autonomous vehicle 10 is sized to navigate effectively indoors and has performance characteristics sufficient to operate on roads.

The autonomous vehicle 10 generally includes a drive assembly 12, a vehicle body 14, and a display assembly 16. The drive assembly 12 includes a vehicle frame 18 that supports a first set of guide wheels 20A and a second set of guide wheels 20B. The first set of guide wheels 20A are rotatably mounted on a first side 18A of the vehicle frame 18 and the second set of guide wheels 20B are rotatably mounted on a second side 18B of the vehicle frame 18. In the example provided, each set of guide wheels 20A, 20B include three guide wheels, though it should be appreciated that more or less guide wheels may be employed. A first road wheel 22A is rotatably engaged with the first set of guide wheels 20A while a second road wheel 22B is rotatably engaged with the second set of guide wheels 20B.

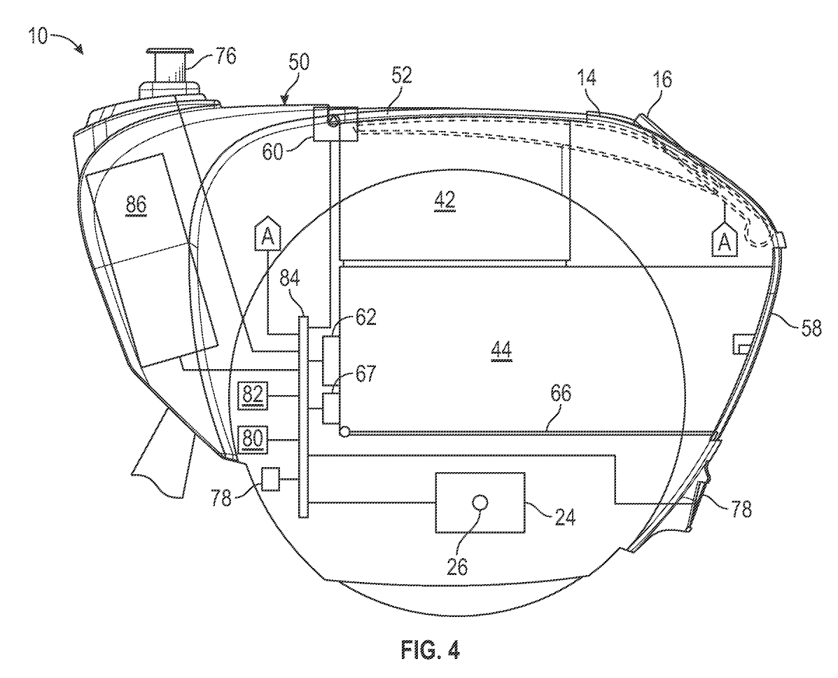

A pair of electric motors 24 (only one of which is shown schematically in FIG. 4) are mounted within the vehicle frame 18. Each electric motor 24 drives an output shaft 26 (only one of which is shown). The output shafts 26 are each connected to rotate a drive wheel 28 (only one of which is shown). Each drive wheel 28 is rotatably engaged with one of the road wheels 22A, 22B. The electric motors 24 supply a driving force to the drive wheels 28 and thus to the road wheels 22A, 22B to move the autonomous vehicle 10. The electric motors 24 may be operated independently and rotated in two directions, thus allowing the autonomous vehicle 10 to move forward, backwards, and to turn left and right depending on which of the electric motors 24 is activated and in which direction the output shafts 26 are rotated. In one example, a third road wheel or rear wheel 30 is mounted to a rear of the vehicle frame 18 to help support the autonomous vehicle 10. The rear wheel 30 may be covered by a housing 32 and may pivot with respect to the vehicle frame 18. An example of a drive assembly 12 is described in FR3052739A1 filed Jun. 21, 2016, herein incorporated by reference in its entirety.

The vehicle body 14 is mounted to the drive assembly 12 and generally provides storage and mounting points for various features of the autonomous vehicle 10. The vehicle body 14 includes exterior side walls 40 and interior walls 42. The exterior side walls 40 are connected to the side walls 18A, 18B of the vehicle frame 18 of the drive assembly 12. The interior walls 42 define a first compartment 44 and a second compartment, or delivery portal, 46. The first compartment 44 is accessible via a first opening 48 located on a top surface 50 of the vehicle body 14. A door 52 is rotatably hinged to the top surface 50 and selectively covers the first opening 48. The second compartment 46 is accessible via a second opening 54 located on a front side 56 of the vehicle body 14. A drawer 58 is slidably disposed within the second compartment 46. In one embodiment, the door 52 is actuated by a device 60 such as an electric motor, servo, or other actuator. The device 60 opens and closes the door 52 to allow access into the first compartment 44. Likewise, the drawer 58 is actuated by a device 62, such as an electric motor coupled to a rack and pinion or a servo controlled armature, to slide the drawer 58 out of and into the compartment 44. In another embodiment, the drawer 58 includes a hinged bottom 66. When the drawer 58 is extended out from the vehicle body 14, the hinged bottom 66 pivots down and drops any object disposed in the drawer 58. When the drawer 58 is retracted into the vehicle body 14, the hinged bottom 66 is forced to pivot closed as the drawer 58 moves into the vehicle body 14. In yet another embodiment, the first compartment 44 communicates with the second compartment 46 within the vehicle body 14. Thus, an object placed in the first compartment 44 when the door 52 is open will drop into the drawer 58 in the second compartment 46. Both the door 52 and the drawer 58 may include locking mechanisms that prevent the door 52 and the drawer 58 from opening.

In one embodiment, a temperature control device 67 is connected to the first compartment 44 and/or the second compartment 46. The temperature control device 67 is a heating and/or cooling mechanism that is configured to regulate a temperature of the environment within the first compartment 44 and/or the second compartment 46. The vehicle body 14 may include insulation surrounding the compartments 44, 46 to assist in temperature control.

The display assembly 16 is attached to the front side 56 of the vehicle body 14 above the second opening 54. The display assembly 16 includes a touchscreen user interface and display 68 for receiving and displaying information. In one embodiment, a lighting bar 70 is mounted to the display assembly 16 to provide information regarding use, visibility, feedback, etc. In another embodiment, one or more cameras or depth sensors is mounted to the display assembly 16 to read gestures, detect facial features, assist in the user interface of the touchscreen display 68, etc. In yet another embodiment, the display assembly 16 is hinged to the vehicle body 14. The display assembly 16 is moveable between at least a first position and a second position relative to the vehicle body 14. In the first position, the display assembly 16 is rotated away from the vehicle body 14, as shown in FIG. 1. When in the first position, the autonomous vehicle 10 operates normally. When the display assembly 16 is moved to the second position, shown in FIG. 4, the display assembly 16 is rotated adjacent the vehicle body 14 and a stop command is generated to halt the autonomous vehicle 10. Thus, the display assembly 16 acts as an easily accessible quick stop mechanism to interrupt the travel of the autonomous vehicle 10. In an alternate embodiment, the display assembly 16 includes two rods on each side that holds the ends where the hinges of the display assembly 16 rotates fore and aft, and at the same time these rods allow the display assembly 16 to be pulled manually or actuated to rise up vertically to hand reach without a person having to bend down.

The autonomous vehicle 10 further includes a sensor suite used to provide lane and path navigation as well as object detection. In the example provided, the sensor suite includes front sensors 74 and a LiDAR sensor 76. The front sensors 74 may include cameras or ultrasonic sensors. The front sensors 74 are mounted to a forward-facing portion of the drive assembly 12, though the front sensors 74 may be mounted to the vehicle body 14. The LiDAR sensor 76 is mounted to the top surface 50 of the vehicle body 14 to allow for 360-degree detection. The autonomous vehicle 10 may have additional sensors disposed around the vehicle body 14.

To further assist in autonomous driving, the autonomous vehicle 10 includes a GPS module 78 and a transmitter/receiver module 80. The GPS module 78 provides real-time satellite global positioning of the autonomous vehicle 10. The transmitter/receiver module 80 is configured to communicate wirelessly using various communication protocols (Bluetooth, WiFi, LTE, etc.) with a remote operator. The wireless communication may include vehicle-to-vehicle (V2V), vehicle-to-infrastructure (V2I), vehicle-to-pedestrian (V2P), vehicle-to-device (V2D), and vehicle-to-grid (V2G) communications.

The autonomous vehicle 10 includes a control module 82 that communicates with the display assembly 16, the electric motors 24, the actuation devices 60 and 62, the temperature control device 67, the front sensors 74, and the LiDAR sensor 76 via a CAN, wire harness, or other wiring network 84. The control module 82 is a specific purpose controller having, generally, a processor and a memory device having routines accessible by the processor. The processor may be any conventional processor, such as commercially available CPUs, dedicated application-specific integrated circuit (ASIC), or other hardware-based processor. The memory device may be any computing device readable medium such as hard-drives, solid state memory, ROM, RAM, DVD or any other medium that is capable of storing information that is accessible by the processor. The control module 82 may also be a micro-controller having a micro-processor, memory device, and other peripherals embedded on a single integrated circuit. Although only one control module 82 is shown, it is understood that the autonomous vehicle 10 may include multiple controllers or micro-controllers. The routines include algorithms for generating path and lane data, object detection, image analysis, GPS and object detection fusion, algorithms for generating commands to control the actuation devices 60, 62 and the electric motors 24, and other routines used to autonomously control the autonomous vehicle 10. The control module 82, the display assembly 16, the electric motors 24, the actuation devices 60 and 62, the temperature control device 67, the front sensors 74, and the LiDAR sensor 76 are powered by a power source 86, such as one or more electric batteries.

The autonomous vehicle 10 includes side panels 90 that are connected to the exterior side walls 40 of the vehicle body 14. The side panels 90 protect debris or other objects from being caught between the road wheels 22A, 22B and the vehicle body 14. Wheel or hub caps 92 may be attached to the side panels 90 to display emblems or other information. In one embodiment the wheel caps 92 are magnetically attached to the side panels 90 for easy replacement. In another embodiment, the autonomous vehicle 10 includes side lights 94 mounted on the vehicle body 14.

The autonomous vehicle 10 may be used to autonomously transport objects between locations. For example, a user may call the autonomous vehicle 10 to her location using a phone that communicates with the autonomous vehicle 10 using V2D communication. The autonomous vehicle 10 then navigates to the location of the user and requests an input code or other identification from the user via the display assembly 16. The user then inputs the code, or the autonomous vehicle 10 uses facial identification, and opens the door 52. The user then places an object into the first compartment 44. Where the compartments 44 and 46 are connected, the object falls into the drawer 58. The user then indicates that the object has been loaded and a destination location, either by voice command or an input into the display assembly 16. Alternatively, the autonomous vehicle 10 may receive instructions remotely using V2I or V2D communication. The autonomous vehicle 10 then travels to the destination location using on-board autonomous driving routines and controls, as noted above. Once the autonomous vehicle 10 arrives at the destination, the drawer 58 may then be opened automatically and the object delivered or dropped when the hinged bottom 66 of the drawer 58 opens. Alternatively, autonomous vehicle 10 may request an input code or other identification via the display assembly 16 before unlocking the door 52 or the drawer 58.

The description of the invention is merely exemplary in nature and variations that do not depart from the gist of the invention are intended to be within the scope of the invention. Such variations are not to be regarded as a departure from the spirit and scope of the invention.

The following is claimed:

1. An autonomous vehicle for transporting an item from a first location to a second location, the autonomous vehicle comprising:
a frame having a first set of three guide wheels rotatably mounted on a first side of the frame and a second set of three guide wheels rotatably mounted on a second side of the frame;
a pair of road wheels, each of the pair of road wheels is rotatably engaged with each of the first and second set of three guide wheels;
a pair of electric motors mounted to the frame, each of the pair of electric motors has an output shaft rotatably driven by the electric motor;
a pair of drive wheels each of the pair of drive wheels is rotatably engaged with each of the pair of road wheels and with the output shafts of the electric motors to transfer a driving force generated by the electric motors from each of the output shafts to rotate each of the pair of drive wheels;
a vehicle body having exterior side walls and interior side walls, wherein the exterior side walls of the body are mounted to the frame;
a compartment defined by the interior side walls of the body;
sensors mounted on the frame for collecting data for determining an environment in which the vehicle is operating;
a control module for processing data received by the sensors and controlling the electric motors to move the vehicle in the environment according to instructions sent by a remote source; and
a user interface in communication with the control module for providing a means to communicate information to or receive information from the vehicle.

2. The autonomous vehicle of claim 1, wherein the body further comprises a delivery portal for depositing the item at the second location.

3. The autonomous vehicle of claim 2, wherein the delivery portal is in communication with the compartment for receiving the item disposed in the compartment.

4. The autonomous vehicle of claim 3, further comprising a third road wheel rotatably connected to the vehicle body.

5. The autonomous vehicle of claim 1, further comprising a drawer slidably disposed within the delivery portal.

6. The autonomous vehicle of claim 5 wherein the drawer includes a hinged bottom that opens when the drawer is extended from the vehicle body.

7. The autonomous vehicle of claim 5 wherein the drawer is connected to an actuator that automatically extends and retracts the drawer upon command by the control module.

8. The autonomous vehicle of claim 1 further comprising a door disposed overtop the compartment.

9. The autonomous vehicle of claim 8 wherein the door is connected to an actuator that automatically opens and closes the door upon command by the control module.

10. The autonomous vehicle of claim 1 wherein the user interface is rotatingly connected to the vehicle body and is capable of moving vertically away from the vehicle body.

11. The autonomous vehicle of claim 1 wherein the user interface is moveable between a first position where the user interface is rotated away from the vehicle body and a second position where the user interface is rotated against the vehicle body.

12. The autonomous vehicle of claim 11 wherein the user interface is located on a front surface of the vehicle body.

13. The autonomous vehicle of claim 12 wherein when the user interface is in the second position the autonomous vehicle is halted.

14. The autonomous vehicle of claim 1 wherein the compartment and the delivery portal are temperature controlled by the control module.

15. The autonomous vehicle of claim 1 wherein the sensors include a camera and a LiDAR.

16. The autonomous vehicle of claim 1 further comprising a delivery portal in communication with the compartment, wherein the compartment is accessible via a top of the vehicle body and the delivery portal is accessible via a front of the vehicle body.

17. An autonomous vehicle for transporting an item from a first location to a second location, the autonomous vehicle comprising:
a vehicle frame having a first set of three guide wheels rotatably mounted on a first side of the frame and a second set of three guide wheels rotatably mounted on a second side of the frame;
a pair of road wheels, each of the pair of road wheels is rotatably engaged with each of the first and second set of three guide wheels;
a pair of electric motors mounted to the frame, each of the pair of electric motors has an output shaft rotatably driven by the electric motor;
a pair of drive wheels each of the pair of drive wheels is rotatably engaged with each of the pair of road wheels and with the output shafts of the electric motors to transfer a driving force generated by the electric motors from each of the output shafts to rotate each of the pair of drive wheels;
a vehicle body having exterior side walls and interior side walls, wherein the exterior side walls of the body are mounted to the frame;
a compartment defined by the interior side walls of the body;
a delivery portal for depositing the item at the second location;
sensors mounted on the frame for collecting data for determining an environment in which the vehicle is operating;
a control module for processing data received by the sensors and controlling the electric motors to move the vehicle in the environment according to instructions sent by a remote source; and
a user interface in communication with the control module for providing a means to communicate information to or receive information from the vehicle.

18. The autonomous vehicle of claim 17, wherein the delivery portal is in communication with the compartment for receiving the item disposed in the compartment.

19. The autonomous vehicle of claim 17, further comprising a drawer slidably disposed within the delivery portal.

20. The autonomous vehicle of claim 17, further comprising a door disposed overtop the compartment.
